(19) United States
(12) Patent Application Publication
(10) Pub. No.: US 2026/0311345 A1
(43) Pub. Date: Oct. 8, 2026

(54) TRAJECTORY PREDICTION FOR DYNAMIC AGENTS

(71) Applicant: Five AI Limited, Cambridge (GB)

(72) Inventors: Anthony Knittel, Cambridge (GB); Morris Antonello, Cambridge (GB)

(73) Assignee: Five AI Limited, Cambridge (GB)

(21) Appl. No.: 19/479,175

(22) PCT Filed: Apr. 26, 2024
(86) PCT No.: PCT/EP2024/061674

§ 371 Date: Oct. 27, 2025

(30) Foreign Application Priority Data
Apr. 28, 2023 (GB) 2306327.4

(51) Int. Cl. G06T 7/246

(52) U.S. Cl. CPC G06T 7/246; G06T 2207/10016; G06T 2207/20081; G06T 2207/20084; G06T 2207/30196; G06T 2207/30241; G06T 2207/30252

(57) ABSTRACT

A computer-implemented method of predicting an agent trajectory in a world space, the method comprising: receiving a visual input comprising an image of the agent in an image space, extracting from the visual input using a visual feature extractor a set of visual features, receiving a trajectory history input comprising an observed trajectory of the agent in the world space, extracting from the trajectory history input a set of trajectory features, and generating, based on the set of visual features and the set of trajectory features, a prediction output comprising a predicted trajectory for the agent in the world space.

### TECHNICAL FIELD

The present disclosure pertains to agent trajectory prediction, which has applications, for example, in autonomous driving and robotics.

### BACKGROUND

Within a robotic system (such as an autonomous driving system), predicted agent trajectories may be used as a basis to autonomously plan an ego trajectory for a robot (e.g. autonomous vehicle), referred to as the ego agent.

Autonomous Vehicles (AV) operate in areas where pedestrians are present, and prediction of pedestrian behaviour is important for avoiding conflict, which is particularly important with vulnerable road users (VRUs). Pedestrian prediction is hard since they can change direction and start or stop moving, and it is high risk, for example if they enter a road area. Producing conservative estimates of pedestrian motion allows potential actions to be captured and avoided, however can lead to very conservative driving of an AV and prevent progress of the AV.

### SUMMARY

To address the issue of overly-conservative autonomous driving behaviour in the presence of pedestrians and other vulnerable road users (such as cyclists), trajectory-based predictions techniques are provided herein which incorporate visual appearance information to more accurately identify when changes of motion occur, and thus more accurately predict a future trajectory of a VRU.

Methods which predict future motion based only on an observed history of positions are limited in an important respect. When changes of motion take place, such as initiation of motion to enter a road area from a stationary position, there is a delay before the motion can be accurately observed in the trajectory, and used to make an accurate prediction of motion. Noise is always present in the estimated position, and the greater the noise the later that motion initiation can be reliably observed.

In practice, this means that often motion is only clearly observed in the history of positions after the pedestrian has entered the road, making purely trajectory-based predictors less suitable for VRUs in particular.

This problem is addressed herein using appearance data to inform trajectory prediction. The visual appearance information enables motion changes to be detected earlier than pure trajectory-based methods.

The prediction techniques disclosed herein are particularly well suited to the task of predicting pedestrian trajectories, or trajectories of other vulnerable road users (VRUs), using visual ‘cues’ in combination with historic trajectories.

A first aspect herein provides a computer-implemented method of predicting an agent trajectory in a world space, the method comprising: receiving a visual input comprising an image of the agent in an image space; extracting from the visual input using a visual feature extractor a set of visual features; receiving a trajectory history input comprising an observed trajectory of the agent in the world space; extracting from the trajectory history input a set of trajectory features; and generating, based on the set of visual features and the set of trajectory features, a prediction output comprising a predicted trajectory for the agent in the world space.

Embodiments utilize vision-based classification of motion changes (e.g. motion initiations) to inform trajectory prediction.

Image features in the image space are thus used to guide trajectory prediction in the world space.

The world space (world coordinate system) may, for example, be defined by coordinates within a ground plane (or world plane), which encode a ‘bird's-eye-view’ (or top-down view) of the agent and its surroundings. The world space may be two-dimensional, or three-dimensional (with the addition of a height coordinate above the ground plane). In this case, the observed and predicted trajectories have coordinates in the ground plane (as possibly height coordinates as well). For example, each trajectory may comprise a sequence of historic/predicted agent locations, each defined by a set of ground plane (and, in some cases, height) coordinates. Trajectory features may be extracted in the ground plane (e.g. via temporal convolution).

The image space may be defined by image coordinates in an image plane lying substantially perpendicular to the ground plane, or more generally non-parallel to it. The image space may be two-dimensional, or three-dimensional with the addition of a depth coordinate.

The image features may be extracted in the image plane (with additional temporal convolution in some embodiments).

The visual input may comprise a time sequence of images of the agent (appearance frames), such as agent images cropped from a video sequence.

The set of trajectory features may, for example, be extracted via one or more temporal convolution operations applied to the trajectory history input.

The visual feature extractor may, for example, have a neural network architecture. For example, in the described embodiments, the visual feature extractor, has the form of a 2D convolutional neural network (CNN) feature extractor that extracts visual features in the image space from each appearance frame independently, and a temporal convolution processing component that combines those visual features.

The 2D CNN feature extractor may, for example, comprise a 2D CNN that processes the appearance frames sequentially, or multiple 2D CNNs that process the appearance frames in parallel.

A second aspect herein provides a computer-implemented method of training a machine learning visual feature extractor, the method comprising:
receiving a training image of an agent in an image space;
receiving a known trajectory in a world space associated with the training image;
automatically determining a motion state ground truth associated with the training image based on the trajectory in the world space; and
extracting using the visual feature extractor a set of visual features from the training image;
using the extracted visual features to compute a predicted motion state; and
training the visual feature extractor based on the predicted motion state and the ground truth motion state.

The training may comprise tuning parameters of the visual feature extractor based on a training loss that measures error in the predicted motion state relative to the ground truth motion state.

The groundtruth/predicted motion states may be, e.g. motion classes (motion classification) or numerical motion value (motion regression).

### BRIEF DESCRIPTION OF FIGURES

For a better understanding of the present subject matter, illustrative embodiments are described below by way of example only.

FIG. 1 shows a schematic block diagram of an autonomous vehicle stack;

FIG. 2 illustrates a schematic block diagram of a neural network architecture for interactive prediction;

FIG. 3 is an example of cropped pedestrian appearance, showing gait change with motion initiation;

FIG. 4 is a schematic block diagram of an appearance-based model for predicting agent trajectories;

FIG. 5 shows examples of prediction inputs and outputs; and

FIG. 6 is a schematic block diagram of a model for motion state prediction.

### DETAILED DESCRIPTION

The ability to anticipate pedestrian motion changes is a critical capability for autonomous vehicles. In urban environments, pedestrians may begin to move to legally cross the road, or may walk in the roadway without considering rules and oncoming traffic. Motion is only clearly observed after the pedestrian has entered the road, making purely trajectory-based predictors less suitable. It is recognized herein that appearance data can inform trajectory prediction and classification of motion changes, e.g. motion initiations, earlier. Many prediction methods have been proposed, but they might not consider appearance data or produce diverse probabilistic trajectories. A comparative evaluation of multiple methods is detailed. Methods are presented herein that can predict trajectories and motion states from trajectory and appearance data, showing the benefits of considering multiple input and output modalities. Two trajectory and image datasets from the popular NuScenes dataset are created and from observations on real-world autonomous vehicle runs, analysing instances with motion changes.

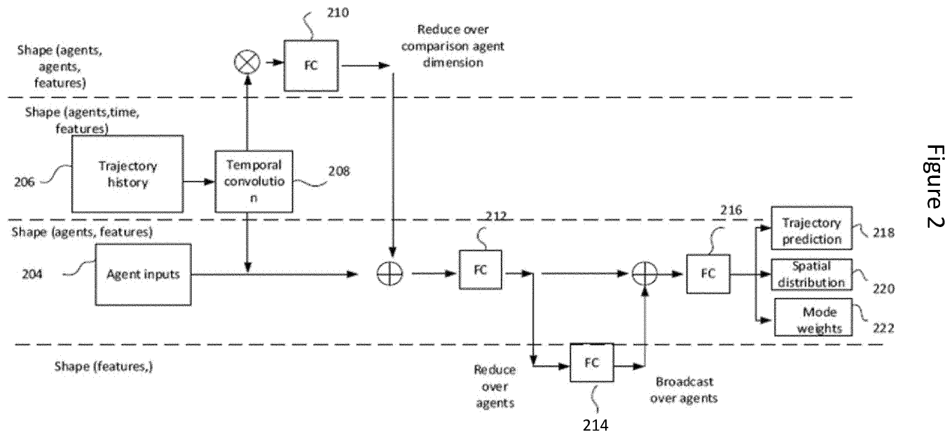

FIG. 2 shows a neural network-based, multi-modal prediction architecture referred to as DiPA (Diverse and Probabilistically Accurate Interactive Prediction), which generates predicted trajectories, with spatial distribution parameters (e.g. mean and covariance) and mode prediction weights for different prediction modes.

The present prediction architecture is incorporated in the DiPA architecture in one embodiment.

FIG. 2 is a schematic block diagram of an example neural network architecture that may be used to perform interaction-based agent trajectory prediction, for example to predict agent trajectories for agents of a driving scenario based on which an autonomous vehicle stack can plan a safe trajectory. The network receives a set of trajectory histories 206 comprising a set of past states for each agent of a scenario. Each trajectory history may be in the form of a time series of agent states over some past time interval, each state including the position, orientation and velocity of the agent at a corresponding point in time. At least one past agent state is received for each agent. Other agent inputs 204 may also be received, such as a set of spatial dimensions for each agent. These agent inputs and agent histories may be derived from sensor data by a perception subsystem 102 of an AV stack 100. The trajectory histories are processed by one or more temporal convolution layers 208 to generate a feature vector for each agent that is time-independent.

As shown in FIG. 2, the set of trajectory histories 206 is an array having shape (agents, time, features), i.e. for each agent, a set of features is input defining the state of the agent at each timestep of the time interval. Note that ‘features’ is used herein to refer to a representative set of values, and different feature representations are used in different parts of the network. In other words, ‘features’ when used to describe a dimension of an input or output of the network can refer to different numbers and types of features for different inputs and outputs. For the trajectory history, for example, the feature values represent the position, orientation and velocity of the agent at the selected point in time, and the features output from the temporal convolution represent the states of the agent over the entire time interval. Note that the dimensionality shown in FIG. 2 excludes the feature dimension.

The convolved trajectory histories are broadcast over all agents as shown by the ⊗ symbol, for example by concatenating the feature vector for each agent with each feature vector associated with each other agent of the scenario. Each combination of two agents is associated with a respective pairwise feature, which is processed by one or more interaction layers 210 of the neural network. These may be fully connected (FC) layers as shown. The output of the interaction layers 210 is a respective feature vector for each pairwise combination of agents, which is subsequently reduced (aggregated) over one agent dimension. Note that each agent is treated as an independent input to the network, similarly to elements of a batch, rather than as components of a single input that the network learns to process according to an assigned role.

For clarity, herein a first agent of each pair is referred to as the ‘reference’ agent while the second agent of the pair is referred to as the ‘comparison’ agent. All agents of the scenario act as both a reference agent and a comparison agent. The reduction is over the comparison agent dimension, such that a respective interaction representation is output for each agent of the scenario. Example reduction operations include max reductions, where for a given reference agent the maximum value for each feature is selected over all comparison agents, and a sum, which gives the sum of each feature over all the comparison agents. The reduced interaction representation feature vectors, which have dimension (agents, features) is combined with the additional agent inputs, as well as the convolved histories, which also have dimension (agents, features), although, as noted above, the number of features for the interaction representation and the agent inputs need not be the same. These are combined in the present example by concatenating the agent input (combined with the convolved agent histories) and the interaction representation vector for each agent as shown by the ⊗ in FIG. 2. This combined feature representation for each agent is processed by a set of prediction layers 212 and 216. A scene context may also be generated by reducing an intermediate output of a first set of prediction layers 212 and processing this in a set of context layers 214, with the output being broadcast to the intermediate output for each agent, for example by concatenating the scene context with each intermediate output as generated for each agent, before processing the combined agent representations in a second set of prediction layers 216 to generate a final predicted output including a trajectory prediction 218. In the present example, the neural network is configured to make predictions for each of a fixed number of prediction ‘modes’, where the number of modes, for example five, is predetermined. The output generates a predicted trajectory 218 for each mode, as well as a spatial distribution 220 indicating uncertainty of the trajectory itself in space, as well as a weight 222 (such as a mode probability) which indicates a predicted mode, where the mode with the highest weight is the mode that the network determines is the most likely for the given agent.

Reference is made to our co-pending United Kingdom Patent Application No. 2208732.4 filed on 14 Jun. 2022, and to [4], each of which is incorporated herein by reference in its entirety. Further details of the DiPA architecture are described therein.

The DiPA architecture provides an effective mechanism for evaluating multimodal predictions in the context of prediction of road users, which considers the various possibilities that should be considered, and evaluating the accuracy of the distribution of predictions. In the present context, the usefulness of this architecture for pedestrian motion prediction, such as changes of motion, is recognized as it provides a general method for evaluating a distribution of future multimodal states.

Note that, whilst the ‘full’ DiPA architecture includes the extraction of pairwise interaction features (‘agent×agent’), the use of this is optional. An interaction layer 210 is shown as the top layer at the top of FIG. 2, but this layer is not necessarily required in the present context. Hence, the interaction layer 210 may be omitted, or deactivated. In this case, agents are considered individually, without explicitly modelling agent interactions. FIG. 2 also shows a global feature layer at the bottom, which can also be omitted or deactivated in this case. This layer combines the features between the various agents in the scene, and is not required when only handling a single agent at a time.

As an alternative to deactivating the interaction layer, it could be retained, but configured to handle only a single agent at a time (the DiPA architecture is capable of handling a varying number of agents, including a single agent at a time, and can therefore be configured to operate with the number of agents set to one).

Experiments are described below, which have been run on a single agent at a time to highlight the effect of introducing appearance for prediction of individual agents.

However, in a multi-agent setting, the interaction and global layers may be retained, handling multiple agents at a time, making full use of the interactive DiPA architecture.

A middle agent prediction layer is shown to have three inputs: trajectory history, agent inputs (as in DiPA), and the additional visual features. The agent inputs may, for example, comprise agent dimensions. For pedestrian/VRU prediction, these can be set to a reasonably representative and predetermined value (e.g. 1 meter×1 meter).

The outputs to the network are unchanged.

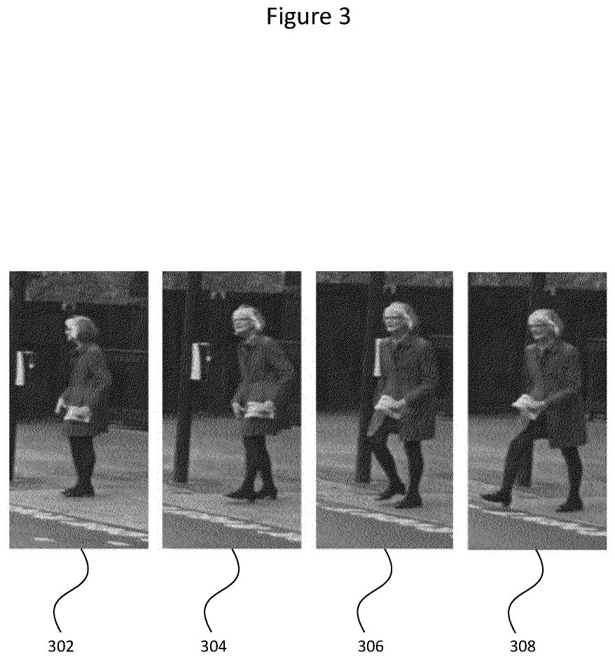

Appearance cues such as changes of body pose provide additional information of the actions of pedestrians, such as when gait is changing in order to begin or stop moving. These appearance cues can reliably inform when motion changes are taking place, and provide an early and accurate signal of motion. FIG. 3 illustrates an example pedestrian appearance, showing gait change with motion initiation.

A first image 302 shows a pedestrian waiting at a crossing on a pavement at the side of a road. In this image, both feet of the pedestrian are stood on the pavement. A second image 304 shows the pedestrian moving closer to the edge of the pavement. In a third image 306, the pedestrian is shown to be at the edge of the pavement. In this image, the pedestrian is stood such that they appear to intend on walking closer the edge of the pavement, towards the road. In a fourth image 308, the pedestrian is seen to leave the pavement and cross the edge such that they have now stepped onto the road.

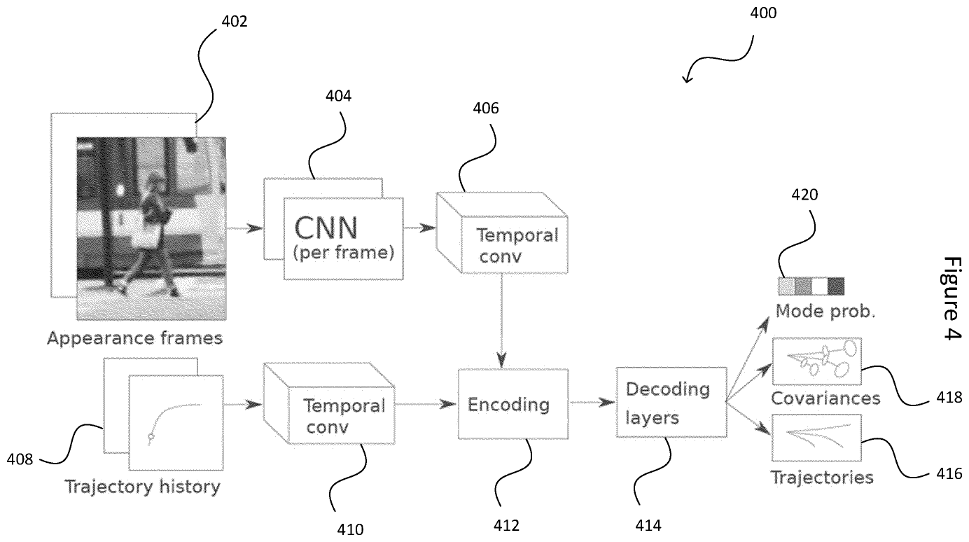

The motion cues in the images presented in FIG. 3 may be used by a trained neural network to inform trajectory-based motion prediction. For example, a visual feature extractor described below with reference to FIG. 4 may use these images to predict the motion of a pedestrian.

Existing methods have used pedestrian appearance to estimate whether a pedestrian intends to cross the road, and to inform prediction of the future position of the pedestrian in the camera view. Common datasets for these experiments are PIE [1] and JAAD [2], [3]. These methods have demonstrated the ability to classify pedestrian crossing intent, and to improve prediction of future positions within the camera view.

The way that these experiments can contribute to the operation of an autonomous vehicle is not clear, as the way that classification of pedestrian intent and prediction within the camera space can inform the control of an AV has not been shown, and further stages of processing would be needed. Pedestrian intent is judgement-based, and needs to be manually annotated for each instance of the dataset. Prediction within the camera frame would need to be performed before fusion of information between various camera views and modalities, and it is unclear how well it can inform the future position of a pedestrian in the world space.

Prediction of pedestrian motion is inherently a multimodal task—if a pedestrian is standing beside the road area there are at least two significant possibilities to consider, of whether they remain stationary or begin moving into the road, which would create a hazard for the AV. A multimodal predictor can create a predicted trajectory for each mode, and assign a probability estimate for each event.

An experimental task is evaluated herein for pedestrian prediction, that includes a dataset of cropped images of pedestrians, along with their associated trajectory in world coordinates. This dataset is constructed using data from the nuScenes dataset [5], which combines camera information with trajectories of pedestrians in the world space, to produce an experimental task for prediction of pedestrians including the use of observed appearance. This experiment uses a history of images and trajectory positions for a pedestrian, and predicting future positions, evaluated using the multimodal prediction measures. [4]. This experimental task allows a model to predict modes of behaviour, such as motion initiation and standing still, using the appearance of pedestrians to provide cues when changes of motion take place.

To solve this task a network architecture that uses a CNN-based model for interpreting pedestrian appearance is presented herein, which is used along with the DiPA trajectory predictor, and show that this model improves over prediction using trajectory history alone. This shows that pedestrian appearance such as changes of gait, are informative for estimating the future trajectory modes of pedestrians, using a prediction representation that can be used by an AV planner to control the vehicle while avoiding potential conflicts with pedestrians.

### EXPERIMENTS

Multiple prediction models are compared on real data collected from an AV. The data includes pedestrian trajectories, and cropped images of appearance for each timestep along the trajectory. Given histories of length 1 s, trajectory prediction is then evaluated at 1, 2 and 3 s. Multi-modal trajectories with spatial distributions are predicted, and evaluated with standard trajectory error measures: minADE/FDE, predRMS, weightRMS and NLL. These measures evaluate closest-mode prediction in addition to probabilistic estimates, which provide complementary evaluations of prediction accuracy, as described in [4]. An effective predictor needs to perform well on each measure, indicating the ability to capture distinct modes of behaviour, as well as accurate estimates of the probability that each will occur.

The use of appearance as an observation can assist with identifying changes of motion, and to focus on this task a dataset selection is created that emphasises instances involving changes of motion, in addition to the full dataset.

Predictions are produced using 5 modes, which are encoded using a predicted trajectory position for each timestep, as well as a covariance matrix representing the spatial error distribution, and a probability weight for each predicted mode. Calculation of the evaluation measures minADE/FDE, predRMS and NLL are described in [4]. In addition, the weightRMS evaluation is used, as this provides an estimate of trajectory prediction error weighted by probability estimates, that improves over the predRMS evaluation as it considers each of the mode prediction weights not just the most probable. weightRMS is calculated as follows, for each instance n∈N, mode m∈M, mode weight Wₘ, ground-truth position x and predicted trajectory position μ:

$$weightRMS = \sqrt{\frac{1}{N} {\sum }_{n}^{N} {\sum }_{m}^{M} {W}_{m} {‖ {x}_{n , t} - {μ}_{m , t} ‖}^{2}} \qquad ( 1 )$$

Experiments are conducted using the proposed appearance-based trajectory predictor, which is compared against a number of trajectory-only predictors, including kinematic prediction and a neural-network trajectory predictor (DiPA [4]) that has been demonstrated as effective for prediction of road users including pedestrians. The kinematic predictor predicts a single predicted trajectory mode, while the neural network predictor and appearance network produce trajectories with covariances and mode estimates, and are evaluated using multi-modal evaluations.

### Datasets

Two distinct autonomous driving datasets are analysed. The first dataset is built from the popular large-scale autonomous driving dataset NuScenes [5]. It contains sensor data collected from a fleet of autonomous vehicles operating in various urban environments. It includes 3D trajectory annotations at 2 Hz and camera images at a variable rate (10 or 20 Hz). When synchronising trajectory annotations with camera images, trajectories are interpolated at 10 Hz and synchronised with the closest camera images. Pedestrian instances are selected and maintain the original train, validation and test split. The second dataset is obtained from data-gathering runs with the Five AI vehicle fleet in urban areas of London and Millbrook (UK). It contains trajectory annotations and camera images at 30 Hz. Pedestrian instances are selected and split the datasets into train (70%), validation (10%) and test (20%) based on the pedestrian instance ID. These datasets include camera images from different views, e.g. front-left, front-right etc cameras. Since each pedestrian can be visible from multiple views, the datasets contain multiple samples, one for each view. From each pedestrian instance, cropped regions of images are collected in each available camera view, along with the world trajectory coordinates. The cropped region is expanded to be a loose crop of the pedestrian region, with constant aspect ratio, and rescaled to a common size of 192×192.

### Experimental Method(s)

The described method processes a sequence of cropped pedestrian images as an input, which is combined with the DiPA [4] trajectory predictor backbone to predict multimodal future trajectories of predictions. An overview of the model 400 is shown in FIG. 4.

FIG. 4 shows a schematic block diagram of an overview of an appearance-based model 400. Visual inputs 402 of pedestrian appearance of objects is encoded per frame by a visual feature extractor 404. The visual feature extractor may be a CNN 404. The extracted visual features may be interpreted over time using temporal convolutions 406. For example, the temporal convolution component 406 may combine the visual features of the visual inputs 402. Trajectory history input 408 comprising an observed trajectory is received by a temporal convolution component 410. Image and trajectory encodings 412 are combined and decoded by decoding layers 414 to produce predictions of multimodal trajectories 416, covariances 418 and mode probabilities 420 to estimate future motion states of pedestrians. The trajectory prediction network (bottom row) uses the DiPA predictor, described with reference to FIG. 2, operating with a single agent at a time to focus on the contribution of appearance features for improving multimodal trajectory prediction.

One consideration for observing object appearance from the point of view of an autonomous vehicle, is that the camera is moving with the vehicle, and the detected region of each identified pedestrian will contain errors, resulting in visual effects such as background motion and misalignment between sequential frames, which can interfere with processing of visual features. To compensate for these effects, the proposed model 400 processes a sequence of independent image frames 402 using image features (two-dimensional), without the use of time-based video features (three dimensional including time). Video-based models of human motion such as C3D [6] or I3D [7] are based on datasets using stationary cameras, and the use on data including cropping errors and camera motion will produce feature responses from background motion and interfere with learning. Instead the proposed model 400 uses a sequence of image-based feature processing 404, followed by temporal convolutions 406 to allow inference between frames over time.

Trajectory histories 408 are provided as input to another temporal convolution component 408. Each trajectory history comprises an observed trajectory of an agent in a world space. A set of trajectory features are extracted from the trajectory history.

The encoded features representing appearance are concatenated with the trajectory encoding features 412, and fed into the trajectory decoder 414 to produce predictions of trajectory positions 416 in the world space, covariance estimates 418 and mode probabilities 420. As a moving camera is used the relationship between view orientation and the world space is different in various instances and frames, and it is not feasible to predict trajectory positions or covariances directly from appearance. Appearance can inform future motion states, such as initiation of motion, which can be captured in specific predicted behaviour modes. To allow this to be captured by the network, the appearance network is trained based on the loss of predicted behaviour modes, and not using the trajectory or covariance losses.

Each model, appearance- or trajectory-based prediction, is most relevant for a range of cases, and the different models operate based on different information about the scene. Combining the models allows prediction that is better informed than each individual model. The output of the model 400 is represented by a set of trajectories 416 with corresponding confidence weights. Each trajectory is described as a series of positions at a number of future time-steps, encoded with a position and covariance matrix. This set of weighted trajectories is an encoding of the predicted probability distribution over space and time. The proposed method is a semi-integrated neural-network based approach, where observed trajectory, appearance and/or scene data is provided as input, and a set of predicted trajectories and confidence weights are produced for the agent of interest. Trajectory prediction is based on DiPA [4]. Appearance of objects is encoded as a feature vector extracted from a Convolutional Neural Network (CNN), which learns to predict future motion states from appearance, such as whether a pedestrian moves, or remains stationary. This is trained on motion states automatically estimated from trajectory data. Feature responses from the trained network are then fed as input to a joint appearance-trajectory network, with an option of performing integrated training of motion states and trajectory prediction.

### Experimental Results

Multiple methods are compared on the two presented datasets using standard trajectory error metrics. Baselines include a Constant Velocity (CV) and a Decaying Acceleration (DA) model. In past works, e.g. [8], the DA model was shown to improve over CV and Constant Acceleration (CA) since a constant acceleration model can be more accurate than a constant velocity model in the short term, but it can be very inaccurate in the long term. Considering accelerations can help predicting motion profile changes, e.g. motion initiations, but its estimates might not be accurate. Two implementations are tested, one (App-net) uses a CNN (MobileNetV3Small [9]) which is trained against the mode prediction loss, and a second implementation (App-pose) using pre-calculated pose features [10] which are passed to the temporal convolution layer as a vector of 17×2 features of pose positions in the image. These appearance-based predictors allow visual cues to influence predicted trajectories, and the estimates of probabilities of each trajectory mode. Results are reported in Tables I and II.

TABLE I
Comparison on the NuScenes-Appearance dataset.

| Dataset | | Full | | | Motion Changes | | |
|---|---|---|---|---|---|---|---|
| Time Horizon | | 1 s | 2 s | 3 s | 1 s | 2 s | 3 s |
| RMS | CV | 0.20 | 0.49 | 0.84 | 0.36 | 0.88 | 1.47 |
| | DA | 0.25 | 0.59 | 0.98 | 0.40 | 0.98 | 1.61 |
| predRMS | DiPA [4] | 0.18 | 0.42 | 0.73 | 0.31 | 0.75 | 1.25 |
| | App-net | 0.18 | 0.44 | 0.75 | 0.31 | 0.76 | 1.27 |
| | App-pose | 0.19 | 0.47 | 0.80 | 0.30 | 0.75 | 1.26 |
| minADE | DiPA [4] | 0.03 | 0.08 | 0.13 | 0.06 | 0.14 | 0.23 |
| | App-net | 0.04 | 0.08 | 0.14 | 0.07 | 0.15 | 0.24 |
| | App-pose | 0.05 | 0.12 | 0.20 | 0.09 | 0.20 | 0.34 |
| minFDE | DiPA [4] | 0.06 | 0.16 | 0.28 | 0.12 | 0.28 | 0.48 |
| | App-net | 0.07 | 0.16 | 0.29 | 0.12 | 0.29 | 0.49 |
| | App-pose | 0.10 | 0.25 | 0.43 | 0.18 | 0.44 | 0.74 |
| expRMS | DiPA [4] | 0.20 | 0.47 | 0.73 | 0.35 | 0.87 | 1.46 |
| | App-net | 0.20 | 0.48 | 0.81 | 0.36 | 0.87 | 1.45 |
| | App-pose | 0.19 | 0.46 | 0.80 | 0.30 | 0.75 | 1.28 |
| NLL | DiPA [4] | −1.78 | −0.43 | 0.58 | −0.83 | 0.86 | 1.79 |
| | App-net | −1.75 | −0.38 | 0.64 | −0.79 | 0.88 | 1.82 |
| | App-pose | −1.15 | 4.96 | 15.90 | 1.34 | 16.19 | 26.81 |

TABLE II
Comparison on the Five AI dataset.

| Dataset | | Full | | | Motion Changes | | |
|---|---|---|---|---|---|---|---|
| Time Horizon | | 1 s | 2 s | 3 s | 1 s | 2 s | 3 s |
| minADE | CV | X | Y | Z | X | Y | Z |
| | DA | X | Y | Z | X | Y | Z |
| | DiPA [4] | X | Y | Z | X | Y | Z |
| | Us | X | Y | Z | X | Y | Z |
| minFDE | CV | 0.11 | 0.38 | 0.72 | 0.24 | 0.78 | 1.42 |
| | DA | X | Y | Z | X | Y | Z |
| | DiPA [4] | X | Y | Z | X | Y | Z |
| | Us | X | Y | Z | X | Y | Z |
| predRMS | CV | X | Y | Z | X | Y | Z |
| | DA | X | Y | Z | X | Y | Z |
| | DiPA [4] | X | Y | Z | X | Y | Z |
| | Us | X | Y | Z | X | Y | Z |
| NLL | DiPA [4] | X | Y | Z | X | Y | Z |
| | Us | X | Y | Z | X | Y | Z |

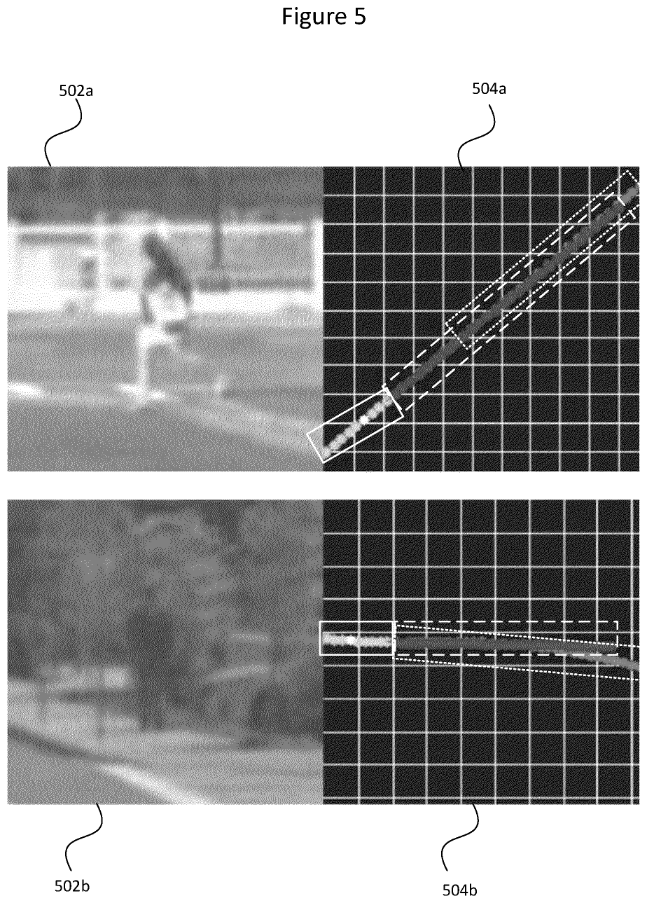

Qualitative examples are included in FIG. 5. FIG. 5 shows examples of prediction input and output. Left images 502a, 502b show cropped appearance data. Right images 504a, 504b show ground-truth (past—solid line, future—dotted line) and predicted (dashed line) trajectory data.

### CONCLUSIONS

In order to operate an autonomous vehicle in the vicinity of pedestrians, it is important to be able to estimate their future motion, and particularly to identify significant cases such as changes of motion, which can indicate when they may enter the road area. To focus on this problem a new dataset task is introduced to perform estimation of multimodal trajectories, using pedestrian appearance to inform future motion. This experiment task makes new use of the nuScenes dataset, and provides a useful means of training and evaluating prediction that can support the use of an AV. This task improves over previous datasets such as PIE and JAAD, which are limited to the camera frame, by evaluating prediction of motion in the world space, including evaluation of probabilistic estimates of different modes of motion.

To solve this task an appearance-based model is introduced that uses the appearance of pedestrians to improve on prediction of motion, compared to prediction using a trajectory only approach. Comparison with a kinematic model shows that the neural-network trajectory predictor improves over the kinematic model, and the appearance-based model improves over the trajectory-only model. This effect is emphasised when a selection of the dataset is used that includes a higher proportion of instances with changes of motion.

This appearance-based model is useful for prediction of pedestrian motion using camera images from a moving AV, and can support an AV for operating safely when pedestrians are nearby.

The experiment and described method operates for a single pedestrian at a time. This allows the advantages for prediction from appearance to be demonstrated as an independent task. The method can be extended to support the prediction of multiple agents together in a scene, including the use of appearance for each agent. In addition, currently multiple pedestrians may be visible together in an instance, and further improvements can provide masking to allow individual agents to be discriminated and to allow for independent prediction of each.

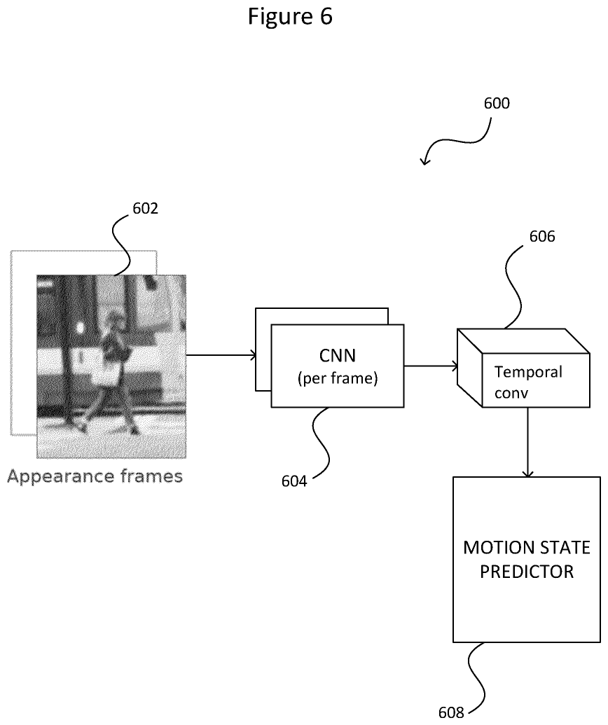

Two variations are considered by way of example. The first uses classification of a motion state to train the appearance network 600. In this case, the appearance network 600 may, for example, be separately trained on a motion state prediction task, as shown in FIG. 6. The training method may be used to train the visual feature extractor 404 described with reference to FIG. 4.

This motion state is based on movement in the world space.

The second is trained using feedback from the trajectory prediction outputs (mode probabilities, covariances and trajectories). In this case, the whole network may be jointly trained on trajectory prediction in the world space.

In the first case, the motion state is based on movement in the world space. When using motion state classification, the appearance network 600 may produce outputs that classify the motion state of the agent in relation to motion classes, e.g., “moving” vs “not moving”, “turning” vs “not turning” and/or other high-level motion classes. Alternatively or additionally, it may predict a motion value, such as or a real-valued estimate of speed (a form of regression). In this case, the appearance network 600 is trained against the actual future motion of the agent, which is known for the samples in the training set. Motion state ground truth used in training is generated automatically from known trajectory data in the world space, which does not require manual annotation.

In the above examples, trajectories are defined in the world plane. For the purpose of training on motion states, a ground truth may be defined according to whether the pedestrian is moving or not moving in the future (after the observation). The appearance network 600 tries to predict if the pedestrian will be moving or not moving. The intention is for the network 600 to identify appearance cues to do this, e.g. it will see that there is a change of pose indicating that they are starting to move, and this will allow classification that the pedestrian will be moving after the observation.

Training is this context refers to systematic tuning of the parameters of a machine learning (ML) component, such as neural network weights, based on a training loss defined on ground truth and corresponding ML outputs. The training loss quantifies error in the ML outputs, by measuring an extend of difference between the ML outputs and the ground truth. For example, gradient-based training methods, such as stochastic gradient descent/ascent, may be used to tune the parameters based on their gradients with respect of the training gloss.

### Example Application

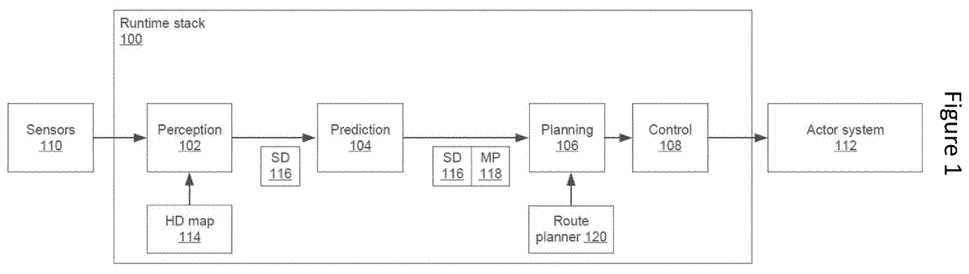

FIG. 1 shows, by way of context, a highly schematic block diagram of an AV runtime stack 100. The stack 100 may be fully or semi-autonomous. For example, the stack 100 may operate as an Autonomous Driving System (ADS) or Advanced Driver Assist System (ADAS).

The run time stack 100 is shown to comprise a perception system 102, a prediction system 104, a planning system (planner) 106 and a control system (controller) 108.

The prediction system comprises the multi-model prediction system described above, which supports trajectory planning in the presence of pedestrian(s)/VRU(s).

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104. The perception outputs from the perception system 102 are used by the prediction system 104 to predict future behaviour of external actors (agents), such as other vehicles, pedestrians and other VRUs in the vicinity of the AV.

As is increasingly common in the AV space, the stack 100 may be subject to simulation-based testing to verify safety and performance. In a simulation context, depending on the nature of the testing, it may or may not be necessary to model the on-board sensor system 100. For example, when only the planner 106 (or only the planner 106 and controller 108) are tested on a ‘perfect’ representation of the scenario (that is, directly on simulator ground truth), simulated sensor data is not required therefore complex sensor modelling is not required. Surrogate model(s) of the perception system 102 (or part(s) of it) can also be used to test planner performance (or planner and controller performance) in the presence of realistic perception errors, without the use of sensor models.

In a simulation-based testing context, the perception system 104 may operate on simulated data of various forms.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner 120, also referred to as a goal generator 120.

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.).

In simulation-based testing, the planner 106 or controller 108 controls a simulated ego agent in a simulation environment that includes simulated pedestrian(s)/VRU(s).

Within the stack 100, a scenario description 116 may be used as a basis for planning and prediction. The scenario description 116 is generated using the perception system 102, together with a high-definition (HD) map 114. By localizing the ego vehicle 114 on the map, it is possible to combine the information extracted in the perception system 104 (including dynamic agent information) with the pre-existing environmental information contained in the HD map 114. The scenario description 116 is, in turn, used as a basis for motion prediction in the prediction system 104, and the resulting motion predictions 118 are used in combination with the scenario description 116 as a basis for planning in the planning system 106.

A “full” stack typically involves everything from processing and interpretation of low-level sensor data (perception), feeding into primary higher-level functions such as prediction and planning, as well as control logic to generate suitable control signals to implement planning-level decisions (e.g. to control braking, steering, acceleration etc.). For autonomous vehicles, level 3 stacks include some logic to implement transition demands and level 4 stacks additionally include some logic for implementing minimum risk maneuvers. The stack may also implement secondary control functions e.g. of signalling, headlights, windscreen wipers etc.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like).

### REFERENCES

[1] Amir Rasouli, Iuliia Kotseruba, Toni Kunic, and John K. Tsotsos. Pie: A large-scale dataset and models for pedestrian intention estimation and trajectory prediction. In The IEEE International Conference on Computer Vision (ICCV), October 2019.
[2] A. Rasouli, I. Kotseruba, and J. K. Tsotsos. Agreeing to cross: How drivers and pedestrians communicate. In 2017 IEEE Intelligent Vehicles Symposium (IV), pages 264-269, 2017.
[3] Amir Rasouli, Iuliia Kotseruba, and John K Tsotsos. Are they going to cross? a benchmark dataset and baseline for pedestrian crosswalk behavior. In Proceedings of the IEEE International Conference on Computer Vision Workshops, pages 206-213, 2017.
[4] Anthony Knittel, Majd Hawasly, Stefano V Albrecht, John Redford, and Subramanian Ramamoorthy. DiPA: Diverse and probabilistically accurate interactive prediction. arXiv preprint arXiv:2210.06106, 2022.
[5] Holger Caesar, Varun Bankiti, Alex H Lang, Sourabh Vora, Venice Erin Liong, Qiang Xu, Anush Krishnan, Yu Pan, Giancarlo Baldan, and Oscar Beijbom. nuscenes: A multimodal dataset for autonomous driving. In Proceedings of the IEEE/CVF conference on computer vision and pattern recognition, pages 11621-11631, 2020.
[6] Du Tran, Lubomir Bourdev, Rob Fergus, Lorenzo Torresani, and Manohar Paluri. Learning spatiotemporal features with 3d convolutional networks. In Proceedings of the IEEE international conference on computer vision, pages 4489-4497, 2015.
[7] Joao Carreira and Andrew Zisserman. Quo vadis, action recognition? a new model and the kinetics dataset. In proceedings of the IEEE Conference on Computer Vision and Pattern Recognition, pages 6299-6308, 2017.
[8] Morris Antonello, Mihai Dobre, Stefano V Albrecht, John Redford, and Subramanian Ramamoorthy. Flash: Fast and light motion prediction for autonomous driving with bayesian inverse planning and learned motion profiles. In 2022IEEE/RSJ International Conference on Intelligent Robots and Systems (IROS), pages 9829-9836. IEEE, 2022.
[9] Andrew Howard, Mark Sandler, Grace Chu, Liang-Chieh Chen, Bo Chen, Mingxing Tan, Weijun Wang, Yukun Zhu, Ruoming Pang, Vijay Vasudevan, et al. Searching for mobilenetv3. In Proceedings of the IEEE/CVF international conference on computer vision, pages 1314-1324, 2019.
[10] Rishabh Bajpai and Deepak Joshi. Movenet: A deep neural network for joint profile prediction across variable walking speeds and slopes. IEEE Transactions on Instrumentation and Measurement, 70:1-11, 2021.

1. A computer-implemented method of predicting an agent trajectory in a world space, the method comprising:
receiving a visual input comprising an image of the agent in an image space;
extracting from the visual input using a visual feature extractor a set of visual features;
receiving a trajectory history input comprising an observed trajectory of the agent in the world space;
extracting from the trajectory history input a set of trajectory features; and
generating, based on the set of visual features and the set of trajectory features, a prediction output comprising a predicted trajectory for the agent in the world space.

2. The method of claim 1, wherein the method comprises encoding the set of visual features with the set of trajectory features to calculate a set of encoded features.

3. The method of claim 2, wherein the method comprises decoding the set of encoded features to generate the prediction output.

4. The method of claim 1, wherein the prediction output additionally comprises covariances and mode probabilities.

5. The method of claim 1, wherein the visual feature extractor extracts the set of visual features in the image space from each visual input independently; and
a temporal convolution processing component combines those visual features.

6. The method of claim 5, wherein the visual feature extractor processes the visual inputs sequentially.

7. The method of claim 1, wherein the world space is defined by coordinates within a ground plane.

8. (canceled)

9. (canceled)

10. The method of claim 7, wherein the observed trajectory and the predicted trajectory have coordinates in the ground plane.

11. (canceled)

12. (canceled)

13. The method of claim 7, wherein the trajectory features are extracted in the ground plane.

14. The method of claim 5, wherein the image space is defined by image coordinates in an image plane lying substantially perpendicular to a ground plane.

15. (canceled)

16. (canceled)

17. The method of claim 14, wherein the image features are extracted in the image plane.

18. The method of claim 1, wherein the visual feature extractor has a neural network architecture; and
wherein the visual feature extractor is optionally a 2D convolutional neural network feature extractor.

19. (canceled)

20. The method of claim 1, wherein the visual input comprises a time sequence of images of the agent.

21. (canceled)

22. The method of claim 20, wherein the visual feature extractor comprises multiple 2D convolutional neural networks that processes the time sequence of images of the agent in parallel.

23. A computer-implemented method of training a machine learning visual feature extractor, the method comprising:
receiving a training image of an agent in an image space;
receiving a known trajectory in a world space associated with the training image;
automatically determining a motion state ground truth associated with the training image based on the trajectory in the world space; and
extracting using the visual feature extractor a set of visual features from the training image;
using the extracted visual features to compute a predicted motion state; and
training the visual feature extractor based on the predicted motion state and the ground truth motion state.

24. The method of claim 23, wherein the training comprises tuning parameters of the visual feature extractor based on a training loss that measures error in the predicted motion state relative to the ground truth motion state.

25. The method of claim 23, wherein the motion state ground truth is a motion class and/or the predicted motion state is a motion class.

26. The method of claim 23, wherein the motion state ground truth is a numerical motion value and/or the predicted motion state is a numeral motion value.

27. (canceled)

28. (canceled)

29. (canceled)

30. A non-transitory computer readable medium embodying computer program instructions, the computer program instructions configured so as, when executed on one or more hardware processors, to implement operations comprising:
receiving a visual input comprising an image of an agent in an image space;
extracting from the visual input using a visual feature extractor a set of visual features;
receiving a trajectory history input comprising an observed trajectory of the agent in a world space;
extracting from the trajectory history input a set of trajectory features; and
generating, based on the set of visual features and the set of trajectory features, a prediction output comprising a predicted trajectory for the agent in the world space.

31. A computer system for predicting an agent trajectory in a world space, the computer system comprising:
at least one memory storing computer-readable instructions; and
at least one processor coupled to the at least one memory configured to execute the computer-readable instructions, which upon execution cause the at least one processor to:
receive a visual input comprising an image of the agent in an image space;
extract from the visual input using a visual feature extractor a set of visual features;
receive a trajectory history input comprising an observed trajectory of the agent in the world space;
extract from the trajectory history input a set of trajectory features; and
generate, based on the set of visual features and the set of trajectory features, a prediction output comprising a predicted trajectory for the agent in the world space.
